(19) United States
(12) Patent Application Publication
(10) Pub. No.: US 2011/0243402 A1
(43) Pub. Date: Oct. 6, 2011

(54) MEASUREMENT SYSTEM FOR MEDICAL IMAGES

(75) Inventor: Timor KADIR, Oxford (GB)

(73) Assignee: Mirada Medical, Oxford (GB)

(21) Appl. No.: 12/954,239

(22) Filed: Nov. 24, 2010

(30) Foreign Application Priority Data
Nov. 30, 2009 (GB) 0920824.0

(51) Int. Cl. G06K 9/00

(52) U.S. Cl. 382/128

(57) ABSTRACT

A method of measuring a structure (510) on a medical image (400) is provided, the structure (510) having a perimeter. A bidirectional measurement object (550) is displayed on the medical image, the bidirectional measurement object (550) comprising a first portion (A) and a second portion (B). The first portion (A) and the second portion (B) cross each other, comprise perpendicular straight lines, and re moveable, relative to each other. The first (A) and second (B) portions may be aligned with the long and sort axes of a tumour, and the lengths of those axes then measured and displayed.

### CROSS-REFERENCE TO RELATED APPLICATIONS

This application claims priority to Great Britain Patent Application 0920824.0, filed Nov. 30, 2009, the entire contents of which are incorporated herein by reference.

### FIELD OF THE INVENTION

The present invention concerns the measurement of images that are generated in the field of medicine.

### BACKGROUND OF THE INVENTION

A variety of technologies can be used to provide medical images, and such images are obtained for a variety of reasons. Typical modern sources of medical images are ultrasound scans, CT scans and MRI scans.

Medical images may include information about a wide variety of anatomical features and structures. For example, one image may show various types of healthy tissue, such as bone, and organs within the body. The image may also show abnormal tissues, such as tumours, cysts or swollen glands. The word ‘tumour’ should henceforth be construed to include other types of tissues.

Medical images need to be read, analysed and reviewed by specialists. This work is often done by radiologists, who are very highly skilled medical practitioners. The cost of such medical imaging tends often to limit the pool of ‘patients’ to humans. However, images may also be obtained of non-human animals, particularly as part of medical research projects.

It is often necessary to estimate the size and volume of anatomical structures that are shown in medical images. These estimates may serve, for example, to monitor the growth of abnormal tissue.

One prior art example where measurements are necessary is in the reading of images from cancer patients. Measurements of the principal dimensions of any suspected tumours are typically required for diagnosis and staging of disease. These measurements are also required for assessing the efficacy of any administered treatment.

In other fields of medicine, it may be necessary to obtain estimates of:

(i) The size of normal anatomy, e.g. organs; or
(ii) Distances or angles between anatomical structures.

Medical images are increasingly obtained and manipulated in digital format. However, much existing medical practice was developed for older, non-digital images.

Non-digital images are 2-dimensional pictures, such as XRay films. When analysing non-digital images, Radiologists obtain measurements directly from the hard copy of the image, using callipers or a ruler.

In digital Radiology, either 2- or 3-dimensional images may be available. Medical imaging workstations commonly provide tools for obtaining the required measurements directly from the displayed images. Examples of the tools available on such workstations are digital callipers or a digital ruler. When working with such tools, the user is typically required to select and then click onto two points on the image. These points are to serve as reference points. The workstation then calculates the real-world distance between the two points, and reports the result in cm or mm.

FIG. 1 shows a conventional unidirectional or linear ruler, available on current medical imaging workstations.

In FIG. 1, reference 100 indicates schematically the outer edge of a medical image. Such an image may, for example, be a cross-section through a human torso.

Reference 110 shows a structure, also in cross-sectional view, that is located on medical image 100. Structure 110 might be a tumour, but might also be an organ.

Reference 120 shows a linear ruler, which is unidirectional. A user has aligned linear ruler 120 between points 122 and 124, having selected these points as being of significance. The user has identified points 122 and 124 as being the end points of the longest diameter of structure 210.

The linear ruler 120 then provides a readout of the distance between points 122 and 124. The readout is shown as 43 mm on FIG. 1. The numerical value of the measurement may be superimposed on the image immediately adjacent to the linear ruler 120, as shown in FIG. 1.

Alternatively, the measurement may be displayed elsewhere on the screen.

An alternative workstation tool displays a virtual ruler. This tool requires the user to click and drag either end of the ruler to the appropriate locations on the medical image. Such tools almost exclusively operate in 2D images, or in 2D slices extracted from 3D images.

The types of measurement of interest on a medical image may include:

(i) The largest diameter in the plane of acquisition of the image. This diameter is known as the ‘long axis’.
(ii) The largest diameter perpendicular to the long axis. This diameter is known as the ‘short axis’.
(iii) The volume.
(iv) One or more other distances.
(v) One or more angles.

The medical sub-speciality of Oncology is the study and practice of treating cancer. Oncology can serve as an illustrative example of what is known in the prior art.

Within the field of oncology, it is common clinical practice to measure the size of suspected tumours. This size measurement is made using the long and short axes, in a particular plane. These are described in (i) and (ii) above. Importantly, the ‘long’ axis is the longestdiameter. The ‘short’ axis is the longest of the axes that lie perpendicular to the long axis.

Two standard methods are in widespread use for the evaluation of treatment response in oncology. These standard methods are referred to as the ‘WHO’ and ‘RECIST’ standards. These methods involve measuring a tumour, in order to compare its state of development with other measurements made earlier and/or later, during the course of treatment.

In the WHO method, each tumour is measured using the long and short axes. The product of these two measurements is then calculated.

With the WHO method, if there are multiple tumours, then the sum of the products for each tumour is calculated. The first time that such a measurement is made, it gives an overall indication of the extent of disease, i.e. in the original scan. When calculated for subsequent followup scans, it can provide an indication of the progression of the disease that can be compared to the original sum.

In the RECIST approach, the calculation is simplified to use only the long axis measurement. When there are multiple tumours, the sum of the long axis measurements for each tumour is used.

In a recent version (RECIST 1.1), the measurement of the short axis is used for assessing lymph-nodes, instead of the measurement of the long axis.

Increasingly, volumetric measurements are becoming of interest in medical imaging. Here it is necessary either to manually delineate the tumour, or to use automated or semi-automated algorithms. Examples of such algorithms are known from the following prior art publications:

### (i) Marie-Pierre Jolly and Leo Grady, “3D General Lesion Segmentation in CT”, Proc. of ISBI 2008, Paris, France, May 14-17 2008. pp. 796-799.

(ii) Radiology reference: ZhaoB, Reeves A P, Yankelevitz D, Henschke C I. Three-dimensional multi-criterion automatic segmentation of pulmonary nodules of helical CT images. Opt Eng 1999; 38:1340-1347.

However, this known prior art has a number of disadvantages.

The digital ruler and calliper tools provided on medical imaging workstations require the user to carry out three manual steps, in the following sequence:

Step 1: Manually select the slice, i.e. the particular 2-dimensional image from amongst all the images that were taken of the structure. Normally, the 2-dimensional image that is selected will be the one that appears to have the longest tumour dimension.
Step 2: On screen, define the start and finish of the long axis measurement, and use a ruler or digital callipers to make the measurement.
Step 3: Also on screen, define the start and finish of the short axis measurement, and use a ruler or digital callipers to make the measurement.

Carrying out steps 1-3 does, however, cause a number of problems.

Problem 1: The selection of the appropriate slice is subjective. In many cases where the image shows a tumour, there could be several appropriate slices, each of which appears to have the longest dimension. The user then has two courses of action available. One approach is to select one of the slices arbitrarily, which may lead to errors. The other approach is to measure each slice and to choose the longest, which can be laborious.

Problem 2: Once the appropriate slice has been selected, the determination of the long axis can also be error prone. This selection also tends to be subject to interclinician variability, i.e. it depends on the particular radiologist. Often the longest dimension of a tumour is not obvious. Again, there may be several directions that might result in the longest measurement, and it will not be obvious which direction to choose. Two users may choose different directions, across which to take the measurement. The differences in direction may be slight, but may also be very large.

Problem 3: Assuming the correct direction has been chosen, the user must judge the appropriate locations in the image at which to specify the ends of the ruler. For some features this is relatively straight-forward. However, for others, the boundary is quite blurred. This blurring will lead to some degree of variability, even between experienced users.

Problem 4: The short axis should be drawn in a direction that is perpendicular to the long axis. Even with this choice, the user is left to do this visually. Once again, this situation leads to both variability and errors in the finally measurement.

FIG. 2 shows a development of FIG. 1. FIG. 2 shows how the long and short axes of an anatomical structure can be defined and measured, using two conventional linear rulers.

FIG. 2 shows only a magnified view of structure 210, which corresponds to structure 110 in FIG. 1. FIG. 2 does not show the entire medical image 100 from FIG. 1.

Reference 220 shows a first linear ruler. A user has aligned linear ruler 220 between points 222 and 224. As in FIG. 1, the user has selected points 222 and 224 as being of significance. The user has identified points 222 and 224 as being the ends of the longest diameter of structure 210. The first linear ruler 220 then provides a readout of the distance between points 222 and 224.

Reference 230 shows a second linear ruler. In FIG. 2, the user is also attempting to measure the ‘short’ axis of structure 210. In order to do this, the user places the ends of second linear ruler 230 on two points 232, 234. The user attempts to find the two such points 232 and 234 on the perimeter of the structure that are furthest apart, along a line perpendicular to first linear ruler 220.

Second linear ruler 230 is a freely moveable linear ruler, and therefore functions as does first linear ruler 220. It is left to the operator to select points 232 and 234, whilst ensuring that these two points lie on an axis that is perpendicular to the axis passing through points 222 and 224.

In addition to problems 1-4 identified above, a further problem arises from using tools such as that shown in FIG. 2 for calculating RECIST or WHO measurements.

As described above, the choice of axis to use in RECIST measurements depends on whether a tumour is a lymph-node or not. Lymph-nodes must be measured using the short axis.

With the prior art, a measurement of the short axis requires that the long axis be defined first. So the user must first draw a long axis ruler.

However, in combining the measurements of multiple tumours for the overall RECIST score, conventional systems have no way of determining which of the measurements from the various rulers on the medical image to use. So conventional systems would therefore sum the measurements from all such rulers, thereby causing an error. One possibility to prevent such an error would be for the user to remove all long axis rulers associated with lymph-nodes from the medical image. This would be an inconvenient and time-consuming process.

Similar problems arise in the WHO calculation. If there are multiple tumours, the system must decide which pair of rulers to use in each product.

Automated and semi-automated volumetric approaches attempt to overcome the limitations of ruler based approaches. They achieve this by enabling the user to define a 2D or 3D segmentation of the tumour. The volume and maximum dimensions can then be derived from such segmentations.

Where the tumour has clear, well-defined boundaries, such techniques can be useful. However, in many cases, tumours exhibit poorly defined boundaries. In addition, tumours are often within or adjacent to tissue of a similar radiological appearance. It is therefore difficult to distinguish tumour tissue from other tissues present in the same region of the image. In such cases, these tools may completely fail to produce a successful result, or may require a significant degree of user intervention.

This can be unsatisfactory, because in many cases the user is compelled to produce an accurate 2D or 3D segmentation, when all that was required was a simple 2D linear measurement.

### SUMMARY OF THE INVENTION

In accordance with a first aspect, the invention provides a method of measuring a structure on a medical image in accordance with claim 1.

In accordance with a second aspect, the invention provides a method of measuring a structure on a medical image in accordance with claim 8.

In accordance with a third aspect, the invention provides a medical image measuring system in accordance with claim 9.

In accordance with a fourth aspect, the present invention provides a computer program product in accordance with claim 12.

The invention may provide a simple, fast, accurate and reproducible method for determining the long and short axes of an anatomical object, such as a tumour or organ.

The invention may solve the problems of defining the direction of the short axis when measuring a structure on a medical image, and of placing the control points of the short axis in an accurate and reproducible manner.

In addition, the invention may simplify the calculation of RECIST and/or WHO statistics.

The invention may provide one or more of the advantages of:

(i) Allowing a user to concentrate on selecting the ends of the ‘short axis’, without the distraction of simultaneously considering the orientation of the short axis relative to the long axis.
(ii) Helping the user to move a measurement object around, within a structure on a medical image. This allows the user very quickly to assess and compare several possible candidate directions for the axes of the structure.

### BRIEF DESCRIPTION OF THE DRAWINGS

FIG. 1 shows a conventional linear ruler.

FIG. 2 shows two conventional linear rulers.

FIG. 3 shows a measurement object in accordance with the invention.

FIG. 4 shows a measurement object in accordance with the invention, displayed with a medical image.

FIGS. 5a-5c show stages of the manipulation of the bidirectional measurement object within the perimeter of a structure on a medical image.

FIGS. 6a-6c show further stages of the manipulation of the bidirectional measurement object within the perimeter of a structure on a medical image.

### DETAILED DESCRIPTION

The invention replaces the conventional linear, unidirectional ruler found in current medical image workstations.

Instead, a bidirectional measurement object is provided.

This object functions as a form of bidirectional ruler, which can measure in two, predetermined, controlled directions. The bidirectional measurement object comprises two portions, which lie along perpendicular axes, and which are displayed on a screen. The axes cross each other, and are held at all times to lie at an angle of 90 degrees to each other. The bidirectional measurement object may be superimposed on a medical image. It may be moved around a medical image, and may be rotated.

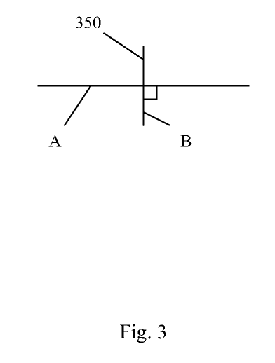

FIG. 3 shows a basic view of the bidirectional measurement object 350. Portion A of bidirectional measurement object 350 lies along a first axis. Portion B lies along a second axis, which is perpendicular to the first axis. Portions A and B are displayed together. The relationship of portions A and B lying at 90 degrees to each other is maintained, no matter what the location or orientation of the bidirectional measurement object 350 on the display.

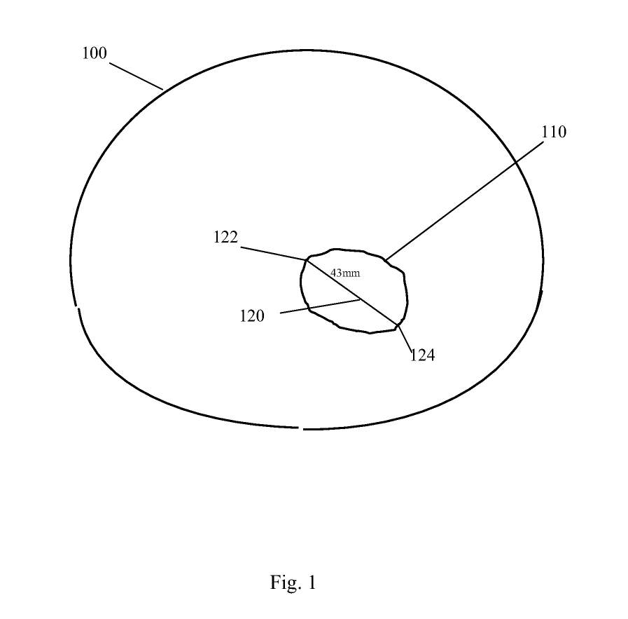

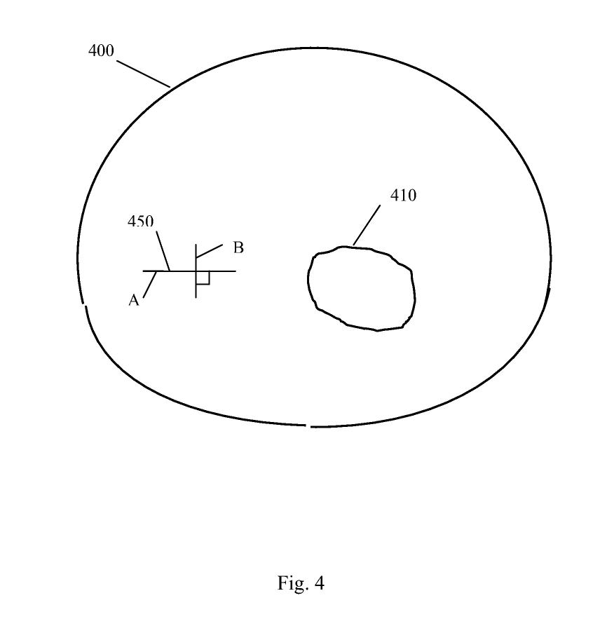

FIG. 4 shows a bidirectional measurement object 450, as displayed on a medical image 400. Medical image 400 and structure 410 correspond to those shown in FIG. 1.

FIG. 4 shows bidirectional measurement object 450 as it might first appear, when a user superimposes it on a medical image 400. Portions A and B are not aligned with any feature on the medical image 400, but remain at 90 degrees to each other.

A user may click onto the bidirectional measurement object 450, for example at the crossing point of portions A and B, and then drag the bidirectional measurement object 450 to a point where a measurement is to be performed.

Alternatively, the bidirectional measurement object 450 may first appear with one end of portion A or portion B located at a point that the user selects, for example a point on the perimeter of structure 410.

In one exemplary embodiment, the tool may works as follows:

(i) Firstly, the user clicks and drags bidirectional measurement object 450 to a location such as structure 410. In this example, we assume that structure 410 is a tumour. The bidirectional measurement object 450 may be configured such that, by grabbing the crossing point of the measurement object with a mouse click, the user may drag the whole tool around the medical image 400.
(ii) The user then locates a first end of one portion, for example portion A, on a first point of interest. This may be done by using a mouse to drag the first end of portion A to the first point of interest. Alternatively, the first end of one portion may automatically move to the next point that the user selects. The selection of the point may be made by a mouse click, or by the user touching a point on the display screen itself.
(iii) The user then locates the second end of portion A on a second point of interest. This may also be achieved by dragging, a mouse click or touching a screen.
(iv) The distance between the first and second points can then be measured and displayed, for example in mm or cm. This is the length that portion A has now attained, to scale, on the screen. If the first and second points are the furthest extremities of structure 410, then portion A measures the ‘long’ axis of the tumour.
(v) The tool then allows the user to define and measure a second axis, by placing the two ends of second portion B on a third point and a fourth point. The second axis may be the short axis of the tumour. At all times, second portion B remains fixed at an angle of 90 degrees to the first portion A. The user can move the position of one portion along the other portion. However, portions A and B always remain on perpendicular axes. This feature may contribute to more rapid operation, and to reduced error rates by users.

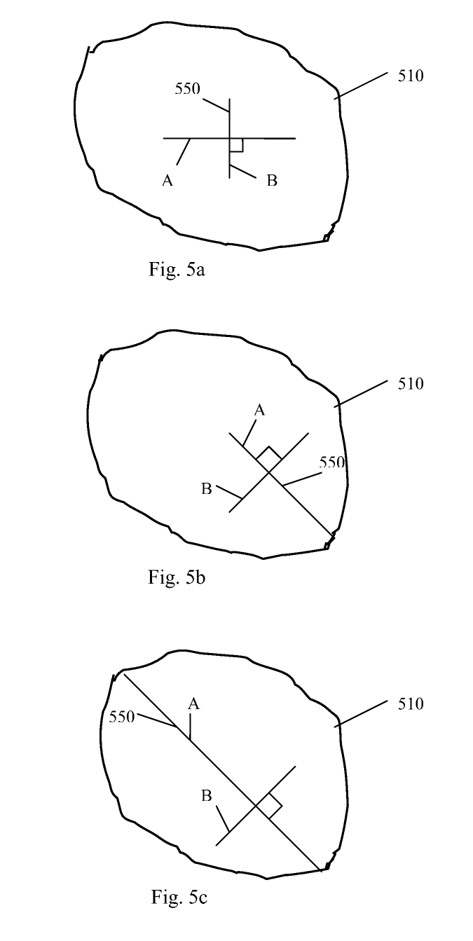

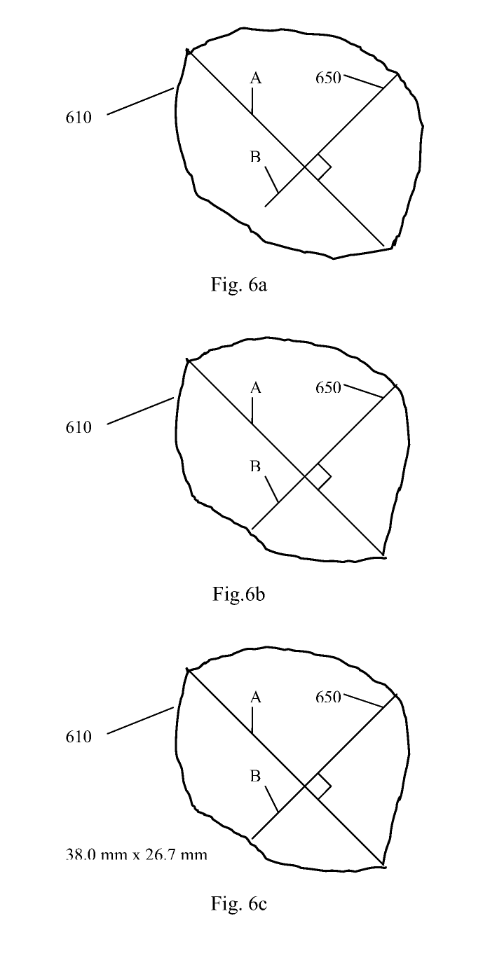

FIGS. 5a-5c illustrate steps (i)-(iv) above. FIGS. 6a and 6b illustrate step (v) above.

In FIG. 5a, bidirectional measurement object 550 is shown within the perimeter of a structure 510 that may form part of a larger medical image.

In FIG. 5b, the user has clicked or dragged a first end of portion A onto a first point on the perimeter of structure 510. The user has judged this first point to be one end of the longest axis of the structure 510.

In FIG. 5c, the user has clicked or dragged the second end of portion A onto a second point on the perimeter of structure 510. The user has judged this second point to be the other end of the longest axis of the structure 510.

In each of FIGS. 5a-5c, second portion B of bidirectional measurement object 550 is displayed to the user, and moves with movements of portion A. However, portion B at all times lies across portion A, at an angle of 90 degrees to portion A.

In summary, FIGS. 5a-5c show the step of aligning portion A with what the user judges to be the long axis of structure 510.

In FIG. 6a, the user has clicked or dragged a first end of portion B onto a third point on the perimeter of structure 610. The user has judged this third point to be one end of the ‘short axis’ of the structure 610. Importantly, the ‘short axis’ of the structure is actually the longest of all the lines that can be drawn within structure 610, perpendicular to the axis along which portion A now lies. This assumes that the user has correctly placed portion A along the long axis.

Bidirectional measurement object 550 allows the user to move one Portion relative to the other Portion. This allows Portion B to be set at an appropriate location, relative to Portion A.

In FIG. 6b, the user has clicked or dragged a second end of portion B onto a fourth point on the perimeter of structure 610. The user has judged this fourth point to be the second end of the ‘short axis’ of structure 610.

Although clicking or dragging has been referred to above, other input actions are possible. For example, movement of a mouse wheel may serve to elongate or shorten portion A and/or portion B.

During the stages illustrated by FIGS. 6a and 6b, compared to the prior art, the invention may provide one or more of the advantages of:

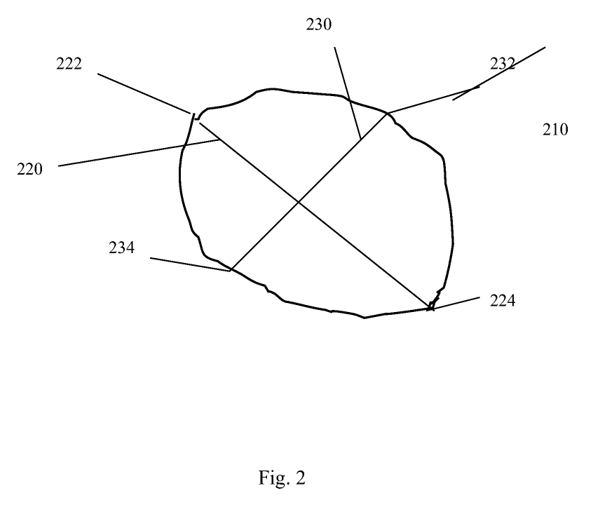

(i) Allowing a user to concentrate on selecting the third and fourth points on the perimeter of structure 610 without the distraction of simultaneously having to consider and adjust the orientation of portion B relative to portion A. This may allow a more accurate selection of the locations of the ends of the ‘short axis’. This is in contrast to the use of a conventional second ruler, such as ruler 230 in FIG. 2.
(ii) Helping the user to move the measurement object 650 around, within structure 610 on the medical image. This allows the user very quickly to assess and compare several possible candidate directions for the long axis of the structure.

FIG. 6c duplicates FIG. 6b. However, FIG. 6c includes a display of the lengths of portions A and B, as they may be shown on the medical image.

The measurement shown for portion A indicates that the long axis of tumour 610 has a length of 38.0 mm. The measurement shown for portion B indicates that the short axis of tumour 610 has a length of 26.7 mm.

The bidirectional measurement object of the invention may facilitate the calculation of RECIST statistics. By associating an indicator flag with each bidirectional measurement object, the user may indicate whether the tumour is a lymph-node or a regular tumour. Thus, when the system is calculating the overall RECIST score, the system may determine which of the two axes to use. If the indicator flag shows that the structure on the image is a lymph node, then the short axis will be used in the RECIST sore. Otherwise, the long axis will be used.

Similarly, the product of the long and short axes required by the WHO standard can also be facilitated using the bidirectional measurement object. This is because there is no need for the user to group together or otherwise indicate which pair of conventional measurement objects should be used in each product calculation.

One variation of the invention is to enable the user to adjust the angle of the two axes such that, whilst they remain attached to one another, they may pivot. Such a variation can allow the measurement of anatomical objects which are complex, and cannot be described accurately using only one pair of axes.

1. A method of measuring a structure (510) on a medical image (400), the structure (510) having a perimeter, comprising:
displaying a bidirectional measurement object (550) on the medical image, the bidirectional measurement object (550) comprising a first portion (A) and a second portion (B), wherein the first portion (A) and the second portion (B):
(ii) cross each other;
(iii) comprise straight lines, held perpendicular to each other; and
(iii) are moveable, relative to each other; and:
selecting a first point on the perimeter of the structure (510), and moving one end of the first portion (A) to the first point;
selecting a second point on the perimeter of the structure (510), and moving the other end of the first portion (A) to the second point;
selecting a third point on the perimeter of the structure (510), and moving one end of the second portion (B) to the third point;
selecting a fourth point on the perimeter of the structure (510), and moving the other end of the second portion (B) to the fourth point;
whereby the first portion (A) connects the first and second points, and the second portion (B) connects the third and fourth points;
measuring the length of at least one of the first portion (A) and the second portion (B).
